(19) United States
(12) Patent Application Publication
(10) Pub. No.: US 2026/0095630 A1
(43) Pub. Date: Apr. 2, 2026

(54) CONFIGURATION METHOD OF ITEMS IN A LIVE STREAMING ROOM, ELECTRONIC DEVICE AND NON-TRANSITORY COMPUTER-READABLE STORAGE MEDIUM

(71) Applicant: Beijing Youzhuju Network Technology Co., Ltd., Beijing (CN)

(72) Inventors: Wei LUO, Beijing (CN); Wanxu Xu, Beijing (CN); Xiaojiao Zhong, Beijing (CN)

(21) Appl. No.: 18/991,134

(22) Filed: Dec. 20, 2024

(30) Foreign Application Priority Data
Sep. 30, 2024 (CN) 202411388331.7

(51) Int. Cl. H04N 21/478; H04N 21/2187

(52) U.S. Cl. CPC H04N 21/47815; H04N 21/2187

(57) ABSTRACT

The present disclosure relates to a configuration method of items in a live streaming room, an electronic device, a non-transitory computer-readable storage medium, and relates to the technical field of computers. The configuration method of items in a live streaming room includes: displaying a first interface in response to an item configuration function in the live streaming room being triggered; in response to that no item is configured for the live streaming room, determining a layout of the first interface as a first layout for recommending items for the live streaming room; and in response to that item(s) are configured for the live streaming room, determining a layout of the first interface as a second layout for displaying the item(s) configured for the live streaming room, the second layout being different from the first layout.

### CROSS-REFERENCE TO RELATED APPLICATIONS

The present disclosure is based on and claims the priority of Chinese Patent Application No. 202411388331.7, filed on Sep. 30, 2024, the disclosure of which is hereby incorporated into this disclosure by reference in its entirety.

### TECHNICAL FIELD

The present disclosure relates to the technical field of computers, in particular to a configuration method of items in a live streaming room, an electronic device, a non-transitory computer-readable storage medium.

### BACKGROUND

Live streaming is a real-time interactive method. At present, through configured with items, many live streaming rooms can facilitate the audience in the live streaming room to buy interested items during the live streaming.

Before the live streaming, the streamer can select the items configured for this live streaming room from the item library of the live streaming room.

### SUMMARY

This Summary section is provided to introduce concepts in a brief form, which will be described in detail in the Detailed Description below. This Summary section is not intended to identify key features or essential features of the claimed technical solution, nor is it intended to limit the scope of the claimed technical solution.

According to some embodiments of the present disclosure, there is provided a configuration method of items in a live streaming room, comprising: displaying a first interface in response to an item configuration function in the live streaming room being triggered; in response to that no item is configured for the live streaming room, determining a layout of the first interface as a first layout for recommending items for the live streaming room; and in response to that item(s) are configured for the live streaming room, determining a layout of the first interface as a second layout for displaying the item(s) configured for the live streaming room, the second layout being different from the first layout.

According to some embodiments of the present disclosure, there is provided an electronic device comprising: a memory; and a processor coupled to the memory, wherein the processor is configured to execute the configuration method of items in a live streaming room of any embodiment described in the present disclosure based on instructions stored in the memory.

According to some embodiments of the present disclosure, there is provided a non-transitory computer-readable storage medium, on which a computer program is stored, which, when executed by a processor, performs the configuration method of items in a live streaming room of any embodiment described in the present disclosure.

Other features and advantages of the present disclosure will become clear through detailed descriptions of the illustrative embodiments of the present disclosure with reference to the following accompanying drawings.

### BRIEF DESCRIPTION OF THE DRAWINGS

Preferred embodiments of the present disclosure will be described below with reference to the accompanying drawings. The accompanying drawings, which are included in and form a part of this specification together with the detailed description below, are provided to provide a further understanding of the present disclosure, and serve to explain the present disclosure. It should be understood that the drawings in the following description only relate to some embodiments of the present disclosure, and do not constitute a limitation of the present disclosure.

FIG. 1 shows a schematic diagram of a shopping bag interface of a live streaming room according to some embodiments of the present disclosure.

FIG. 2 shows a flow diagram of a configuration method of items in a live streaming room according to some embodiments of the present disclosure.

FIG. 3 shows a schematic diagram of a first interface with a first layout according to some embodiments of the present disclosure.

FIG. 4 shows a schematic diagram of a first interface with a second layout according to some embodiments of the present disclosure.

FIG. 5 shows a schematic diagram of a second interface according to some embodiments of the present disclosure.

FIG. 6 shows a schematic diagram of a first interface with a first layout according to other embodiments of the present disclosure.

FIG. 7 shows a schematic diagram of a third interface according to some embodiments of the present disclosure.

FIG. 8 shows a structural schematic diagram of a configuration apparatus of items in a live streaming room according to some embodiments of the present disclosure.

FIG. 9 shows a structural schematic diagram of an electronic device according to some embodiments of the present disclosure.

FIG. 10 shows a structural schematic diagram of a computer system according to some embodiments of the present disclosure.

It should be understood that for the convenience of description, the respective parts shown in the drawings are not drawn in sizes according to actual proportional relations. The same or similar reference numbers are used throughout the drawings to refer to the same or like parts. Therefore, once an item is defined in one drawing, it may not be discussed further in subsequent drawings.

### DETAILED DESCRIPTION

The technical solutions in the embodiments of the present disclosure will be clearly and completely described below with reference to the accompanying drawings in the embodiments of the present disclosure. Obviously, the described embodiments are only a part of the embodiments of the present disclosure instead of all of them. The following description of the embodiments is actually illustrative, but shall not set any limitation on the present disclosure and its application or utilization. It should be understood that the present disclosure can be embodied in various forms and should not be construed as limited to the embodiments set forth herein.

It should be understood that the various steps recited in the method embodiments of the present disclosure may be performed in a different order, and/or performed in parallel. Moreover, the method embodiments may include additional steps and/or omit performing the illustrated steps. The scope of the present disclosure is not limited in this respect. Unless otherwise specified, respective arrangements, mathematic expressions and values of the components and steps illustrated in these embodiments should be interpreted as merely exemplary and not limiting the scope of the present disclosure.

The term “include” and its variants used in the present disclosure means an open term including at least the following elements/features, but not excluding other elements/features, that is, “include but not limited to”. The term “based on” means “based at least in part on”.

References throughout this specification to “one embodiment”, “some embodiments” or “embodiments” means that a particular feature, structure or characteristic described in connection with an embodiment is included in at least one embodiment of the present invention. For example, the term “some embodiments” means “at least some embodiments”. Moreover, the appearances of the phrase “in some embodiments” in various places throughout the specification do not necessarily all refer to the same embodiment, but may also refer to the same embodiment.

It should be noted that the terms “first”, “second”, and the like in the present disclosure are only used for distinguishing different devices, modules or units, and are not used for limiting the order of functions performed by the devices, modules or units or interdependence thereof. Unless otherwise specified, the concepts of “first” and “second” are not intended to imply that the objects so described must be in a given order in time, space, ranking or in any other way.

It is noted that references to “a” or “a plurality of” mentioned in the present disclosure are intended to be illustrative rather than limiting, and those skilled in the art will appreciate that unless otherwise clearly indicated in the context, they should be understood as “one or more”.

Embodiments of the present disclosure will be described in detail with reference to the accompanying drawings, but the present disclosure is not limited to these specific embodiments. The following specific embodiments can be combined with each other, and the same or similar concepts or processes may not be repeated in some embodiments. Furthermore, in one or more embodiments, specific features, structures, or characteristics may be combined in any suitable manner that will be clear from the present disclosure by those ordinary skill in the art.

After the streamer in the live streaming room triggers the item selection function (such as “shopping bag” or “Products” function), if there is no item currently configured for the live streaming room, an empty shopping bag will be displayed to the streamer. If the streamer selects items configured for the live streaming room, the configured items appear in the shopping bag.

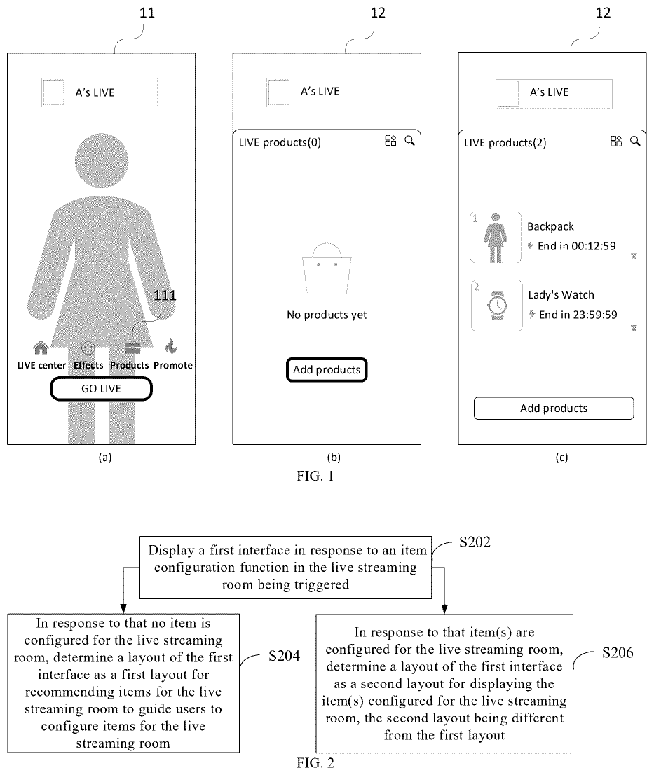

FIG. 1 shows a schematic diagram of a shopping bag interface of a live streaming room according to some embodiments of the present disclosure. As shown in (a) of FIG. 1, home page 11 of the live streaming room can have a “Products” control 111, and after the shopping bag function is triggered, that is, the “Products” control 111 is triggered, an interface 12 is displayed. If nothing has been configured for the live streaming room, as shown in FIG. 1(b), the interface 12 shows a state that the shopping bag is empty. If the streamer or other users with the management authority of the live streaming room (hereinafter referred to as the management user of the live streaming room) configure items for the live streaming room through an add operation, the interface 12 can display the items configured for the live streaming room as shown in (c).

However, some users do not know how to operate further, or have no strong will to choose items when they are faced with an empty shopping bag, because they are not skilled in operation or are not familiar with the live streaming process. As a result, the addition rate of items for the live streaming room is relatively low. When the audience in the live streaming room views the items configured for the live streaming room in the process of live streaming, the number of items is small and they cannot buy their favorite items, which makes the user experience still have room for further improvement.

The embodiments of the present disclosure provide a configuration method of items for a live streaming room. The method of the embodiments of the present disclosure displays shopping bags of the live streaming room in different layouts according to whether item(s) are configured for the live streaming room, so as to guide users to configure items for the live streaming room.

FIG. 2 shows a flow diagram of a configuration method of items in a live streaming room according to some embodiments of the present disclosure. As shown in FIG. 2, the configuration method of this embodiment includes steps S202 to S206.

In step S202, a first interface is displayed in response to an item configuration function in the live streaming room being triggered.

The item configuration function can be triggered by the streamer user or the management user of the live streaming room. The user can trigger the item configuration function in an interface associated with the live streaming room. For example, the first interface may be displayed by triggering a control of item configuration function, such as control 111 in FIG. 1(a). The interface associated with the live streaming room can be the interface for starting the live streaming or a Settings interface during the live streaming. Of course, the item configuration function of the live streaming room can also be triggered in other ways, for example, it can be triggered by other users associated with the live streaming room, or it can be triggered automatically under specified conditions, etc. The present disclosure does not limit this.

The first interface is used to trigger the configuration of items, or to trigger the process of users selecting items for the live streaming room. The items configured for the live streaming room are the items to be displayed in the live streaming room, that is, items that the audience in the live streaming room can browse and buy during the live streaming.

The first interface can have two different layouts, and switch between different layouts according to whether items are currently configured for the live streaming room. Different layouts include one or more display modules that are not exactly the same, or display different contents in the same display module, and so on. Specifically, it is shown in steps S204 and S206.

In step S204, in response to that no item is configured for the live streaming room, a layout of the first interface is determined as a first layout for recommending items for the live streaming room to guide users to configure items for the live streaming room.

When there is no item configured for the live streaming room, that is, when the shopping bag of the live streaming room is “empty”, the first interface is displayed with the first layout. At this time, the first interface is mainly used to recommend items to users, so as to guide users to select item(s) to add to the item(s) configured for the live streaming room.

In step S206, in response to that item(s) are configured for the live streaming room, a layout of the first interface is determined as a second layout for displaying the item(s) configured for the live streaming room, the second layout being different from the first layout.

In the case where item(s) are configured for the live streaming room, that is, the shopping bag in the live streaming room is not “empty.”, the first interface is displayed with the second layout. At this time, the first interface is mainly for displaying the user's configuration result of the items for the live streaming room.

After that, the live streaming can be performed based on the configured items, that is, the configured items are displayed in the live streaming room. For example, a shopping control can be displayed in the live interface of the live streaming room. The configured item(s) for the live streaming room are displayed in response to the trigger operation of the audience in the live streaming room on the shopping control in the live streaming room interface. Therefore, the user can know the information of the configured item(s) or purchase an configured item.

The above embodiment can dynamically determine the interface layout after the user triggers the item selection function according to the configuration condition of the items for the live streaming room. In a case that the user does not configure item(s) for the live streaming room, the user is guided to configure item(s) for the live streaming room through the first layout. Therefore, the configuration rate and configuration efficiency of item(s) in the live streaming room are improved. In addition, with the change of the configuration condition of the item(s) for the live streaming room, the layout can be switched, so as to facilitate the user to know the current configuration condition in the case where item(s) are configured for the live streaming room. This way of switching the layout of the interface based on the configuration condition of item(s) can effectively convey information matching the current situation of the live streaming room to users. Therefore, the user can be clear about the operation to be taken, and the operation efficiency and convenience of the user are improved.

The first layout and the second layout can be realized in various ways. The following is an exemplary description.

The first layout can be used to recommend configurable items to users, so as to save the time for users to select items and improve the operation efficiency. For example, the first interface of the first layout may include an item recommendation area, which includes a first item set recommended for the live streaming room. The items recommended for the live streaming room can be determined according to one or more of the user portrait of the streamer, the historical item configuration information or historical sales information of the live streaming room, or platform recommended items.

The item recommendation area can be understood as a display module in the interface for displaying one or more items recommended for the live streaming room. Therefore, in response to triggering the item configuration function and no item is currently configured, the user can directly know which item(s) can be configured at present, so that the items can be configured efficiently.

In some embodiments, the first interface with the first layout includes an item recommendation area and does not include a configured item area. That is, in the first interface of the first layout, an empty configured item area is not displayed, instead of displaying the configured item area in an “empty” state. Therefore, the importance of the item recommendation area in the interface can be improved, and the display of the configured item area with no information can be reduced, which improves the information transmission efficiency and reduces the negative feelings brought to users.

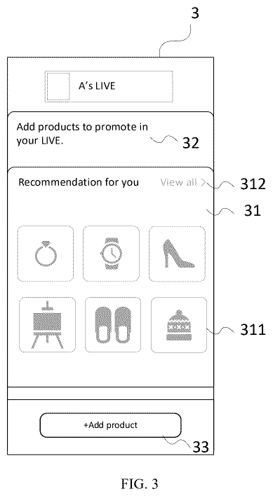

An example of the first interface with the first layout can refer to FIG. 3. FIG. 3 shows a schematic diagram of a first interface with a first layout according to some embodiments of the present disclosure. In a first interface 3 in FIG. 3, an item recommendation area 31 is displayed, which includes several items for the user's reference. Moreover, compared with FIG. 1(b), FIG. 3 does not include a configured item area. FIG. 3 exemplarily suspends the first interface 3 above the startup page of the live streaming room and displays the first interface 3 in a non-full screen mode. As required, the first interface can also be displayed in full screen mode, that is, as an independent page.

The second layout can be used to display the configured items to the user. For example, the second layout can also refer to the pattern of FIG. 1(c). That is, the first interface with the second layout may include a configured item area. The configured items area includes the item(s) configured for the live streaming room.

In order to further improve the item configuration efficiency of the live streaming room, in some embodiments, the first interface with the second layout includes a configured item area and the item recommendation area. Therefore, in a case that the live streaming room has been configured with item(s), items can still be recommended for the live streaming room, so that users can continue to learn about other items efficiently and add configured items.

An example of the first interface with the second layout can refer to FIG. 4. FIG. 4 shows a schematic diagram of a first interface with a second layout according to some embodiments of the present disclosure. In a first interface 4 in FIG. 4, a configured item area 41 and an item recommendation area 42 are displayed. The configured item area 41 includes one or more items configured for the live streaming room, and the item recommendation area 42 also includes one or more items recommended for the live streaming room. Therefore, the second layout can also be different from the pattern in FIG. 1(c), that is, an item recommendation area is added on the basis of FIG. 1(c).

The second layout itself can also be adjusted with the change of a state of the live streaming. In some embodiments, in response to the live streaming room being in a first state, the first interface of the second layout includes the configured item area and the item recommendation area; and in response to the live streaming room being in a second state, the first interface of the second layout includes the configured item area. The first state and the second state can be used to indicate whether the live streaming room is live. That is, when the live streaming room is not live, more items are recommended for the live streaming room for configuration; and when the live streaming room has already started to live, considering that the user has basically determined the items configured for the live streaming room, the item recommendation area is hidden to provide more display space for the configured items.

In some embodiments, in the first interface with the second layout, the display of the item recommendation area can be cancelled, for example, the area can be closed or hidden. In response to the operation of canceling the display of the item recommendation area, the display of the item recommendation area is canceled. For example, in FIG. 4, in response to triggering a close control 421, the item recommendation area 42 may be closed. Of course, the area can also be shrunk or folded through an area fold up control. Therefore, more display space can be reserved for the configured items in the case where users do not need recommendations.

The cancelled item recommendation area can be displayed again. Conditions for displaying the item recommendation area again can be preset. In some embodiments, after the canceling of the display of the item recommendation area, displaying the item recommendation area again in the first interface with the second layout in response to the first item set being updated. That is, when there is a new item recommended to the user, it is recommended to the user through the item recommendation area again. The method of this embodiment may also be carried out in combination with other conditions, for example, after the duration when the user cancels the display of the item recommendation area has exceeded a first specified time, it is determined whether to display the item recommendation area again based on the update condition of the first item set. Therefore, updated recommendation information can be recommended to users, so that users can obtain information in time.

Of course, the re-display of the item recommendation area can also be restricted. For example, if the number of times of the cancelling of the display of the item recommendation area by the user reaches a specified number within a second specified time period, the item recommendation area will not be displayed within the second specified time period, so as to avoid frequent recommendations from disturbing users who do not want to receive recommendations, and improve the user experience.

In the first interface with the first layout or the second layout, if the first interface includes an item recommendation area, the user can add the items in the module to the items configured for the live streaming room directly by triggering them. Alternatively, the interface may not have the recommendation function of recommending items, but only have the function of displaying items, then the user can jump to a new interface to add items by triggering the module (for example, triggering the control in the module).

In some embodiments, a second interface is displayed in response to a trigger operation on an object in the item recommendation area in the first interface, the second interface comprising a second item set recommended for the live streaming room, wherein the first item set is a subset of the second item set. The objects in the item recommendation area can be controls in the area, such as controls corresponding to items, or a “View All” control, and so on. That is, the second interface can show users more recommended items than the first interface.

In the second interface, in response to a selection operation on an item in the second item set in the second interface, the selected item is added to items configured for the live streaming room.

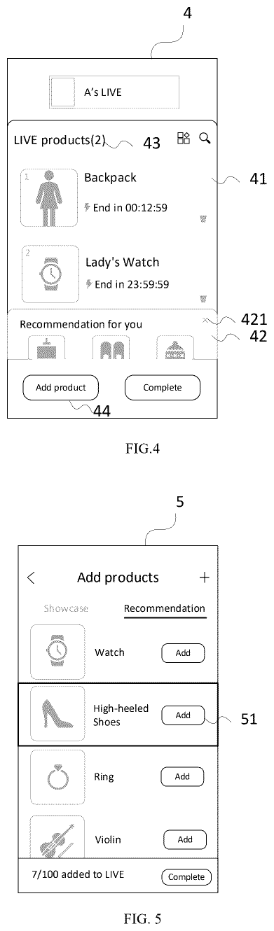

Taking FIG. 3 as an example, the user can trigger a certain recommended item control 311 or a “View All” control 312 to display the second interface. An example of the second interface can be shown in FIG. 5.

FIG. 5 shows a schematic diagram of a second interface according to some embodiments of the present disclosure. In a second interface 5 shown in FIG. 5, one or more items recommended for the user are included. The items may be configured with a selection control 51 to directly add the selected items to the configured items for the live streaming room or to the item library of the live streaming room. The item library can be understood as some optional items pre-determined by users for the live streaming room, and the items configured for the live streaming room can be selected from the item library.

As mentioned above, the user can individually trigger a recommended item in the first interface, for example, trigger the control 311. In this case, the triggered item can be displayed in a specified way. That is, in the first interface, the second interface is displayed in response to a trigger operation on any item in the item recommendation area, wherein the triggered item is displayed in a specified way in the second interface. The display in a specified way is, for example, highlighting or centering, so that users can quickly locate the items triggered in the first interface in the second interface, which improves the user's operation efficiency. If the control 312 is triggered, nothing special may be done on the display way of a certain item.

The items recommended for the live streaming room can be determined in many ways. Several recommendation methods are exemplarily described below.

In some embodiments, the recommended items are determined based on item(s) of historical live streaming. That is, the first item set includes item(s) of historical live streaming for the live streaming room. Item(s) of historical live streaming refer to the items that have been configured for the live streaming of the live streaming room that have ended. The finished live streaming can be further screened as required, for example, items configured for the last live streaming, items configured for the latest specified number of live streaming, or items configured for the latest live streaming within a third specified time period, and so on. Since the item(s) of historical live streaming have a high probability of being reconfigured, the recommended items are more likely to be selected by users again in this way, thus improving the configuration efficiency of the items.

In addition, the function of “one-click configuration” or “one-click add” can be set based on the recommended items. For example, the item recommendation area includes a batch add control, and in response to the trigger of the batch add control, items in the first item set are added to the items configured for the live streaming room. In this way, the operation steps of users in the process of configuring items can be further reduced, and the operation efficiency is improved.

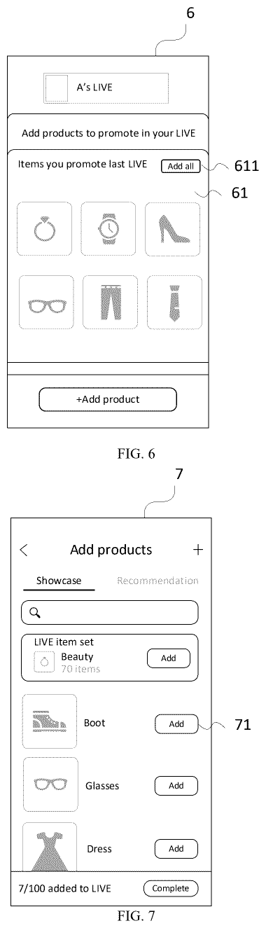

For example, the first item set recommended for the live streaming room is the items configured for the live streaming room during the latest live streaming. By triggering the batch add control, these items can be configured for the live streaming room again, so that users can perform live streaming based on the same items as the previous live streaming. FIG. 6 shows a schematic diagram of a first interface with a first layout according to some embodiments of the present disclosure. As shown in FIG. 6, in a first interface 6, an item recommendation area 61 includes several items configured for the last live streaming and a batch add control 611. In response to the control 611 being triggered, all the items configured for the last live streaming are configured for the live streaming room currently.

In the first interface with the second layout, if both the configured item area and the item recommendation area are displayed, the recommended items can be determined based on the result of the item configuration of the current live streaming room. In some embodiments, the item recommendation area includes an analysis result of items configured in the live streaming room, and the first item set is determined according to the analysis result. The analysis of the items configured in the live streaming room can be any one or more dimensions of statistical data, such as category, brand, price, traffic, feedback and so on. For example, if the currently configured items bring less traffic, some items with more traffic can be recommended. The analysis result can be “The traffic of currently configured items is XX, so it is suggested to add the following items”. The recommendation is done by combining the analysis result, which improves the probability of users adopting the recommended result, and also improves the configuration efficiency and configuration effect of items.

Description information can also be included in the first interface to describe the functions of the current interface. The description information can also be changed under different layouts. In some embodiments, in response to the first interface being the first layout, the first interface comprises guiding information for item selection, that is, the description information is the guiding information for item selection; in response to the first interface being the second layout, the first interface comprises statistical information of the item(s) configured for the live streaming room, that is, the description information is the statistical information of the configured items in the live streaming room. Referring to FIGS. 3 and 4, in the first interface with the first layout shown in FIG. 3, the description information 32 is “Add products to promote in your LIVE”, and in the first interface with the second layout shown in FIG. 4, the description information 43 is “Live products (2)” to describe the number of configured items. Differentiated description information can help users to understand the content of the current interface more efficiently, and the operation efficiency of users is improved.

Users can also add items from the item library. In some embodiments, a third interface is displayed in response to an operation of adding items in the first interface, the third interface comprising one or more alternative items; and in response to a selection of at least one alternative item in the third interface, adding selected items to the items configured for the live streaming room. For example, in response to triggering the add control 33 in the first interface 3 shown in FIG. 3 or the add control 44 in the first interface 4 shown in FIG. 4, the third interface may be displayed.

The third interface may include one or more alternative items pre-selected by the user, so that the user can quickly configure them for the current live streaming room. FIG. 7 shows a schematic diagram of a third interface according to some embodiments of the present disclosure. As shown in FIG. 7, a third interface 7 of this embodiment includes one or more alternative items. In response to a trigger operation of a selection control 71, the item corresponding to the control 71 can be added to the configured items for the live streaming room.

The embodiments of the item configuration method of the present disclosure and the related interface schematic diagrams have been described above. The apparatus for executing the method of the embodiments of the present disclosure is further described below.

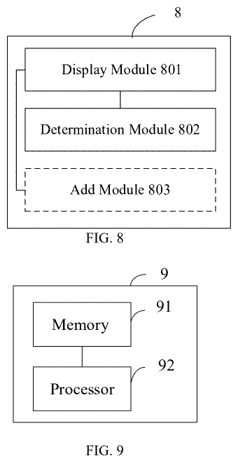

FIG. 8 shows a structural schematic diagram of a configuration apparatus of items in a live streaming room according to some embodiments of the present disclosure. As shown in FIG. 8, the configuration apparatus 8 of this embodiment includes a display module 801 configured to display a first interface in response to an item configuration function in the live streaming room being triggered; a determination module 802 configured to: in response to that no item is configured for the live streaming room, determining a layout of the first interface as a first layout for recommending items for the live streaming room; and in response to that item(s) are configured for the live streaming room, determining a layout of the first interface as a second layout for displaying the item(s) configured for the live streaming room, the second layout being different from the first layout.

In some embodiments, the first interface with the first layout comprises an item recommendation area and does not comprise a configured item area, the item recommendation area comprising a first item set recommended for the live streaming room.

In some embodiments, the first interface with the second layout comprises: a configured item area comprising the item(s) configured for the live streaming room; and an item recommendation area comprising a first item set recommended for the live streaming room.

In some embodiments, in response to the live streaming room being in a first state, the first interface with the second layout comprises: a configured item area comprising the item(s) configured for the live streaming room, and an item recommendation area comprising a first item set recommended for the live streaming room; and in response to the live streaming room being in a second state, the first interface with the second layout comprises a configured item area.

In some embodiments, the display module 801 is further configured to, in the first interface with the second layout, not displaying the item recommendation area in response to an operation of canceling display of the item recommendation area; and after the canceling of the display of the item recommendation area, displaying the item recommendation area again in the first interface with the second layout in response to the first item set being updated.

In some embodiments, the display module 801 is further configured to display a second interface in response to a trigger operation on an object in the item recommendation area in the first interface, the second interface comprising a second item set recommended for the live streaming room, wherein the first item set is a subset of the second item set.

In some embodiments, the display module 801 is further configured to, display the second interface in response to the trigger operation on any item in the item recommendation area in the first interface, wherein the triggered item is displayed in a specified manner in the second interface.

In some embodiments, the configuration apparatus 8 further includes an add module 803.

In some embodiments, the add module 803 is configured to, in response to a selection operation on an item in the second item set in the second interface, add the selected item to items configured for the live streaming room.

In some embodiments, the first item set comprises item(s) of historical live streaming of the live streaming room.

In some embodiments, the item recommendation area includes a batch add control, and the add module 803 is configured to add item(s) in the first item set to the items configured for the live streaming room in response to a triggering for the batch add control.

In some embodiments, the item recommendation area includes an analysis result of item(s) configured for the live streaming room, and the first item set is determined according to the analysis result.

In some embodiments, in response to the first interface being the first layout, the first interface comprises guiding information for item selection; and in response to the first interface being the second layout, the first interface comprises statistical information of the item(s) configured for the live streaming room.

In some embodiments, the display module 801 is further configured to display a third interface in response to an operation of adding items in the first interface, the third interface comprising one or more alternative items; and the add module 803 is further configured to, in response to a selection of at least one alternative item in the third interface, adding selected items to the items configured for the live streaming room.

In some embodiments, the display module 801 is further configured to display the item(s) configured for the live streaming room.

It should be noted that the above-mentioned units are only logical modules divided according to the specific functions they implement, and are not used to limit the specific implementation ways, for example, the functions can be realized in software, hardware or a combination of software and hardware. In actual implementation, the above units can be realized as independent physical entities, or can also be realized by a single entity (for example, a processor (CPU or DSP, etc.), an integrated circuit, etc.). In addition, the above-mentioned units are shown by dotted lines in the drawings, indicating that these units may not actually exist, and the operations/functions they realize may be realized by the processing circuit itself.

In addition, although not shown, the device may also include a memory, which may store various information generated by the device and various units included in the device during operation, programs and data used for operation, data to be transmitted by the communication unit, and the like. The memory may be a volatile memory and/or a nonvolatile memory. For example, the memory may include, but is not limited to, a random access memory (RAM), a dynamic random access memory (DRAM), a static random access memory (SRAM), a read-only memory (ROM), and a flash memory. Of course, the memory may also be located outside the device. Alternatively, although not shown, the device may also include a communication unit, which may be used to communicate with other devices. In an example, the communication unit can be implemented in an appropriate manner known in the art, including, for example, communication components such as antenna arrays and/or radio frequency links, various types of interfaces, communication units, and the like, which will not be described in detail here. In addition, the device may also include other components not shown, such as a radio frequency link, a baseband processing unit, a network interface, a processor, a controller, etc., which will not be described in detail here.

Some embodiments of the present disclosure also provide an electronic device. FIG. 9 shows a structural schematic diagram of an electronic device according to some embodiments of the present disclosure. For example, in some embodiments, the electronic device 9 may be various types of devices, including, for example, but not limited to, a mobile terminal such as a mobile phone, a notebook computer, a digital broadcast receiver, a PDA (personal digital assistant), a PAD (tablet), a PMP (portable multimedia player), a vehicle terminal (e.g., a car navigation terminal), and etc., and a fixed terminal such as a digital TV, a desktop computer, and etc. For example, the electronic device 9 may include a display panel for displaying data and/or execution results utilized in the solution according to the present disclosure. For example, the display panel can be in various shapes, such as a rectangular panel, an oval panel or a polygonal panel. In addition, the display panel can be not only a flat panel, but also a curved panel or even a spherical panel.

As shown in FIG. 9, the electronic device 9 of this embodiment includes a memory 91 and a processor 92 coupled to the memory 91. It should be noted that the components of the electronic device 9 shown in FIG. 9 are only exemplary, not limiting, and the electronic device 9 may have other components according to the actual application requirements. The processor 92 may control other components in the electronic device 9 to execute desired functions.

In some embodiments, the memory 91 is used to store one or more non-transitory computer-readable instructions. When the processor 92 is used to execute the computer-readable instructions, the computer-readable instructions, when executed by the processor 92, implement the method according to any of the above embodiments. For the specific implementation of each step of the method and related explanations, please refer to the above-mentioned embodiments, and the repetition is omitted here.

For example, the processor 92 and the memory 91 can communicate with each other directly or indirectly. For example, the processor 92 and the memory 91 may communicate through a network. The network may include a wireless network, a wired network, and/or any combination of the wireless network and the wired network. The processor 92 and the memory 91 can also communicate with each other through the system bus, and the present disclosure does not limit this.

For example, the processor 92 can be embodied as various appropriate processors, processing devices, etc., such as a central processing unit (CPU), a graphics processing unit (GPU), a network processor (NP), etc. It can also be a digital signal processor (DSP), an application specific integrated circuit (ASIC), a field programmable gate array (FPGA) or other programmable logic devices, discrete gates or transistor logic devices, and discrete hardware components. The central processing unit (CPU) can be X86 or ARM architecture. For example, the memory 91 may include any combination of various forms of computer-readable storage media, such as volatile memory and/or nonvolatile memory. The memory 91 may include, for example, a system memory that stores, for example, an operating system, an application program, a Boot Loader, a database, and other programs, etc. Various applications and data can also be stored in the storage medium.

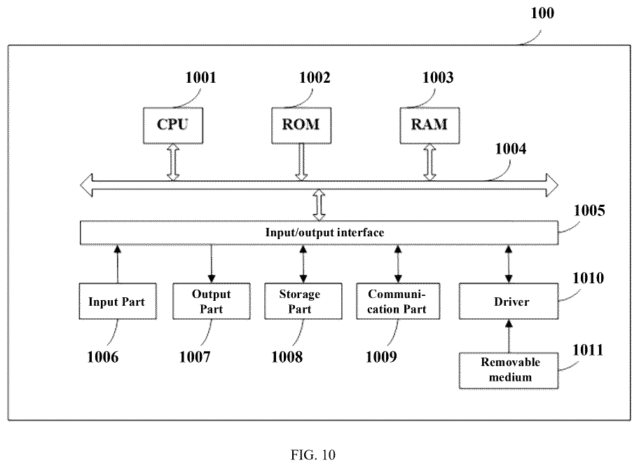

In addition, according to some embodiments of the present disclosure, when various operations/processes according to the present disclosure are realized by software and/or firmware, programs constituting the software can be installed from a storage medium or a network to a computer system with a dedicated hardware structure, such as the computer system 100 shown in FIG. 10. The computer system, when installed with various programs, can perform various functions, including the functions described above. FIG. 10 shows a structural schematic diagram of a computer system according to some embodiments of the present disclosure.

In FIG. 10, a central processing unit (CPU) 1001 performs various processes according to a program stored in a read-only memory (ROM) 1002 or a program loaded from a storage part 1008 into a random access memory (RAM) 1003. In a RAM 1003, data required when the CPU 1001 executes various processes and the like are also stored as necessary. The central processing unit is only exemplary, and it can also be other types of processors, such as the various processors mentioned above. ROM 1002, RAM 1003 and storage part 1008 may be various forms of computer-readable storage media, as described below. It should be noted that although the ROM 1002, the RAM 1003 and the storage device 1008 are shown in FIG. 10 respectively, one or more of them may be merged or located in the same or different memories or storage modules.

The CPU 1001, the ROM 1002 and the RAM 1003 are connected to each other via a bus 1004. An input/output interface 1005 is also connected to the bus 1004.

The following components are connected to the input/output interface 1005: an input part 1006 such as a touch screen, a touch pad, a keyboard, a mouse, an image sensor, a microphone, an accelerometer, a gyroscope, etc.; an output part 1007 including a display such as a cathode ray tube (CRT), a liquid crystal display (LCD), a speaker, a vibrator, etc.; a storage part 1008 including a hard disk, a magnetic tape, etc.; and a communication part 1009 including a network interface card such as a LAN card, a modem, and the like. The communication section 1009 allows communication processing to be performed via a network such as the Internet. It is easy to understand that although FIG. 10 shows that various devices or modules in the computer system 100 communicate through the bus 1004, they may also communicate through a network or other means, wherein the network may include a wireless network, a wired network, and/or any combination of the wireless network and the wired network.

A driver 1010 is also connected to the input/output interface 1005 as needed. A removable medium 1011, such as a magnetic disk, an optical disk, a magneto-optical disk, a semiconductor memory, etc., is mounted on the drive 1010 as needed, so that a computer program read from it is installed in the storage part 1008 as needed.

In the case where the above-mentioned series of processes are realized by software, a program constituting the software may be installed from a network such as the Internet or a storage medium such as the removable medium 1011.

The processes described above with reference to the flow diagrams may be implemented as computer software programs, according to the embodiment of the present disclosure. For example, an embodiment of the present disclosure includes a computer program product comprising a computer program carried on a computer readable medium, the computer program containing program code for performing the method illustrated by the flow diagram. In such an embodiment, the computer program may be downloaded and installed from the network via the communication device 1009, or installed from the storage device 1008, or installed from the ROM 1002. When executed by the CPU 1001, the computer program executes the above-described functions defined in the method of the embodiments of the present disclosure.

It should be noted that in the context of the present disclosure, a computer readable medium may be a tangible medium that can contain, or store a program for use by or in combination with an instruction execution system, apparatus, or device. The computer readable medium may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that contains, or stores a program for use by or in combination with an instruction execution system, apparatus, or device. In contrast, in the present disclosure, a computer readable signal medium may include a data signal propagated in a baseband or as a part of a carrier wave, wherein a computer readable program code is carried therein. Such a propagated data signal may take a variety of forms, including, but not limited to, an electro-magnetic signal, an optical signal, or any suitable combination thereof. A computer-readable signal medium may be any computer readable medium other than a computer-readable storage medium and the computer-readable signal medium can communicate, propagate, or transport a program for use by or in combination with an instruction execution system, apparatus, or device. Program code embodied on a computer-readable medium may be transmitted using any appropriate medium, including but not limited to: electrical wires, optical cables, RF (radio frequency), etc., or any suitable combination thereof.

The computer readable medium may be included in the above-mentioned electronic device; or it may exist alone without being assembled into the electronic device.

In some embodiments, a computer program is also provided, comprising instructions which, when executed by a processor, cause the processor to perform the method of any one of the above embodiments. For example, the instructions may be embodied as computer program codes.

In an embodiment of the present disclosure, computer program code for carrying out operations of the present disclosure may be written in one or more programming languages or a combination thereof, the programming languages include, but are not limited to an object oriented programming language such as Java, Smalltalk, C++, and also include conventional procedural programming languages, such as the “C” programming language, or similar programming languages. The program code can be executed entirely on the user's computer, partly on the user's computer, as an independent software package, partly on the user's computer and partly executed on a remote computer, or entirely on the remote computer or server. In the scenario involving a remote computer, the remote computer may be connected to the user's computer through any type of network, including a Local Area Network (LAN) or a Wide Area Network (WAN), or may be connected to an external computer (for example, through the Internet using an Internet service provider).

The flow diagrams and block diagrams in the figures illustrate the architecture, functionality, and operation that are possibly implemented by systems, methods and computer program products according to various embodiments of the present disclosure. In this regard, each block in the flow diagrams or block diagrams may represent a module, program segment, or portion of code, which comprises one or more executable instructions for implementing the specified logical function(s). It should also be noted that, in some alternative implementations, the functions noted in the blocks may occur in an order different from that noted in the figures. For example, two blocks shown in succession may, in fact, be executed substantially concurrently, or they may sometimes be executed in a reverse order, depending upon the function involved. It will also be noted that each block of the block diagrams and/or flow diagrams, and a combination of blocks in the block diagrams and/or flow diagrams, can be implemented by special purpose hardware-based systems that perform the specified functions or operations, or combinations of special purpose hardware and computer instructions.

The modules, components or units described in the embodiments of the present disclosure may be implemented by software or hardware. Wherein the name of the module, component or unit does not constitute the limitation of the module, component or unit itself in some cases.

The functions described above herein may be performed, at least in part by one or more hardware logic components. For example, without limitation, exemplary types of hardware logic components that may be used include Field Programmable Gate Arrays (FPGAs), Application Specific Integrated Circuits (ASICs), Application Specific Standard Products (ASSPs), Systems on a Chip (SOCs), Complex Programmable Logic Devices (CPLDs), and so forth.

The above descriptions are only some embodiments of the present disclosure and are illustrative of the principles of the technology employed. It will be appreciated by those skilled in the art that the scope of disclosure of the present disclosure is not limited to the technical solutions formed by specific combinations of the above-described technical features, and should also encompass other technical solutions formed by any combination of the above-described technical features or equivalents thereof without departing from the concept of the present disclosure. For example, the technical solutions formed by the above features be replaced with (but not limited to) features having similar functions disclosed in the present disclosure.

In the description provided herein, numerous specific details are set forth. However, it can be understood that embodiments of the present invention may be practiced without these specific details. In other instances, well-known methods, structures and techniques are not shown in detail in order not to obscure the understanding of this description.

Further, although operations are depicted in a particular order, this should not be understood as requiring such operations to be performed in the particular order shown or in sequential order. Under certain circumstances, multitasking and parallel processing may be advantageous. Likewise, although several specific implementation details are included in the above discussion, these should not be construed as limitations on the scope of the present disclosure. Certain features that are described in the context of a single embodiment can also be implemented in combination in the single embodiment. Conversely, various features that are described in the context of a single embodiment can also be implemented in multiple embodiments separately or in any suitable subcombination.

Although some specific embodiments of the present disclosure have been exemplified in detail, it shall be understood by those skilled in the art that the above examples are only illustrative, but shall by no means limit the scope of the present disclosure. Those skilled in the art will appreciate that the above embodiments may be modified without departing from the scope and spirit of the present disclosure. The scope of the present disclosure is defined by the appended claims.

What is claimed is:

1. A configuration method of items for a live streaming room, comprising:
displaying a first interface in response to an item configuration function in the live streaming room being triggered;
in response to that no item is configured for the live streaming room, determining a layout of the first interface as a first layout for recommending items for the live streaming room; and
in response to that item(s) are configured for the live streaming room, determining a layout of the first interface as a second layout for displaying the item(s) configured for the live streaming room, the second layout being different from the first layout.

2. The configuration method according to claim 1, wherein the first interface with the first layout comprises an item recommendation area and does not comprise a configured item area, the item recommendation area comprising a first item set recommended for the live streaming room.

3. The configuration method according to claim 1, wherein the first interface with the second layout comprises:
a configured item area comprising the item(s) configured for the live streaming room; and
an item recommendation area comprising a first item set recommended for the live streaming room.

4. The configuration method according to claim 1, wherein:
in response to the live streaming room being in a first state, the first interface with the second layout comprises:
a configured item area comprising the item(s) configured for the live streaming room, and an item recommendation area comprising a first item set recommended for the live streaming room; and
in response to the live streaming room being in a second state, the first interface with the second layout comprises a configured item area.

5. The configuration method according to claim 3, further comprising:
in the first interface with the second layout, not displaying the item recommendation area in response to an operation of canceling display of the item recommendation area; and
after the canceling of the display of the item recommendation area, displaying the item recommendation area again in the first interface with the second layout in response to the first item set being updated.

6. The configuration method according to claim 4, further comprising:
in the first interface with the second layout, not displaying the item recommendation area in response to an operation of canceling display of the item recommendation area; and
after the canceling of the display of the item recommendation area, displaying the item recommendation area again in the first interface of the second layout in response to the first item set being updated.

7. The configuration method according to claim 2, further comprising:
displaying a second interface in response to a trigger operation on an object in the item recommendation area in the first interface, the second interface comprising a second item set recommended for the live streaming room, wherein the first item set is a subset of the second item set.

8. The configuration method according to claim 3, further comprising:
displaying a second interface in response to a trigger operation on an object in the item recommendation area in the first interface, the second interface comprising a second item set recommended for the live streaming room, wherein the first item set is a subset of the second item set.

9. The configuration method according to claim 7, wherein the displaying the second interface in response to the trigger operation on the object in the item recommendation area in the first interface comprises:
displaying the second interface in response to the trigger operation on any item in the item recommendation area in the first interface, wherein the triggered item is displayed in a specified manner in the second interface.

10. The configuration method according to claim 7, further comprising:
in response to a selection operation on an item in the second item set in the second interface, adding the selected item to items configured for the live streaming room.

11. The configuration method according to claim 2, wherein the first item set comprises item(s) of historical live streaming of the live streaming room.

12. The configuration method according to claim 3, wherein the first item set comprises item(s) of historical live streaming of the live streaming room.

13. The configuration method according to claim 2, wherein the item recommendation area comprises a batch add control, and the configuration method further comprises:
adding item(s) in the first item set to the items configured for the live streaming room in response to a triggering for the batch add control.

14. The configuration method according to claim 3, wherein the item recommendation area comprises a batch add control, and the configuration method further comprises:
adding item(s) in the first item set to the items configured for the live streaming room in response to a triggering for the batch add control.

15. The configuration method according to claim 3, wherein the item recommendation area comprises an analysis result of item(s) configured for the live streaming room, and the first item set is determined according to the analysis result.

16. The configuration method according to claim 1, wherein:
in response to the first interface being the first layout, the first interface comprises guiding information for item selection; and
in response to the first interface being the second layout, the first interface comprises statistical information of the item(s) configured for the live streaming room.

17. The configuration method according to claim 1, further comprising:
displaying a third interface in response to an operation of adding items in the first interface, the third interface comprising one or more alternative items; and
in response to a selection of at least one alternative item in the third interface, adding selected items to the items configured for the live streaming room.

18. The configuration method according to claim 1, further comprising:
displaying the item(s) configured for the live streaming room.

19. An electronic device comprising:
a memory; and
a processor coupled to the memory; the processor being configured to, based on instructions stored in the memory, execute a configuration method of items in a live streaming room comprising:
displaying a first interface in response to an item configuration function in the live streaming room being triggered;
in response to that no item is configured for the live streaming room, determining a layout of the first interface as a first layout for recommending items for the live streaming room; and
in response to that item(s) are configured for the live streaming room, determining a layout of the first interface as a second layout for displaying the item(s) configured for the live streaming room, the second layout being different from the first layout.

20. A non-transitory computer-readable storage medium on which a computer program is stored, which, when executed by a processor, implements a configuration method of items in a live streaming room comprising:
displaying a first interface in response to an item configuration function in the live streaming room being triggered;
in response to that no item is configured for the live streaming room, determining a layout of the first interface as a first layout for recommending items for the live streaming room; and
in response to that item(s) are configured for the live streaming room, determining a layout of the first interface as a second layout for displaying the item(s) configured for the live streaming room, the second layout being different from the first layout.
